(19) United States
(12) Patent Application Publication
(10) Pub. No.: US 2005/0076288 A1
(43) Pub. Date: Apr. 7, 2005

(54) Method for displaying a personal video recorder program schedule in a daily planner style

(75) Inventor: Thomas Poslinski, San Diego, CA (US)

Correspondence Address: FITCH EVEN TABIN & FLANNERY, 120 SOUTH LASALLE SUITE 1600, CHICAGO, IL, 60603, US

(73) Assignees: Sony Corporation, Tokyo (JP); Sony Electronics Inc., Park Ridge, NJ (US)

(21) Appl. No.: 10/678,548

(22) Filed: Oct. 2, 2003

(51) Int. Cl. G06F 15/00

(52) U.S. Cl. 715/500

(57) ABSTRACT

A method of displaying recorded programs comprising the steps of retrieving from memory a listing of programs for a given calendar period; generating a video signal adapted for display on a display monitor, the video signal comprising a calendar representing the given calendar period and including the listing of programs; and outputting the video signal for display on the display monitor. A digital recording device comprising a signal receiver for receiving a content signal; a memory coupled to the signal receiver for storing the content signal; and a processor coupled to the memory, the processor configured to generate a video signal for display on a display monitor, the video signal including a calendar for a given time period, the calendar including a listing of the stored content signal.

### BACKGROUND OF THE INVENTION

1. Field of the Invention

The present invention relates generally to a personal video recorder. Even more specifically, the present invention relates to the display and management of a listing of television programs on a personal video recorder.

2. Discussion of the Related Art

Personal video recorders (PVR), also known as digital video recorders (DVR) are electronic devices that are used for storing audio and video information received over any number of communication channels. The audio and video information is stored as a data file on a memory device of the PVR. Personal video recorders allow a user to setup a timer and record scheduling of television programs. The personal video recorder can also receive program information in the form of a program guide. Navigation and selection of programs through the program guide provides a very convenient way for a user to select programs for future recording. Generally, after a television program has been recorded a record list can be viewed that displays information about the recorded program such as channel number, a program description, a start time and an end time.

Personal video recorders all have some integrated means for recording programs and allowing a user to select programs to record. For example, a user can select a record button while watching a shown or just prior to a show starting. In another example a user can program the record time and channel selection into the PVR or as mention above, select a show to record from a program guide.

As the number of recorded programs increases, the record list can become very long. Additionally, as the amount of memory available for storing video programs in the PVR increases, the number of programs a user will have stored will increase. Thus, the present design of providing a user with a long list of all of the programs they have recorded will become burdensome on the user of the PVR. The longer the list the less convenient it is to attempt to find a replay a show that has been previously recorded. Thus, there is a need for a user to easily find a show that has been previously recorded and to be able to select the show for playback.

### SUMMARY OF THE INVENTION

In one embodiment, the invention can be characterized as a method of displaying recorded programs comprising the steps of retrieving from memory a listing of programs for a given calendar period; generating a video signal adapted for display on a display monitor, the video signal comprising a calendar representing the given calendar period and including the listing of programs; and outputting the video signal for display on the display monitor.

In another embodiment, the invention can be characterized as a digital recording device comprising a signal receiver for receiving a content signal; a memory coupled to the signal receiver for storing the content signal; and a processor coupled to the memory, the processor configured to generate a video signal for display on a display monitor, the video signal including a calendar for a given time period, the calendar including a listing of the stored content signal.

In a further embodiment, the invention may be characterized as a digital recording device comprising a signal receiver for receiving a program guide, the program guide including a plurality of programs; a memory coupled to the signal receiver for storing a list of scheduled programs for recording, the list of scheduled programs for recording selected from the program guide; and a processor coupled to the memory, the processor configured to generate a video signal for display on a display monitor, the video signal including a calendar for a given time period, the calendar including the list of schedule programs for recording.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram illustrating a personal video recorder in accordance with the present invention;

FIG. 2 is a diagram illustrating a main menu that can be displayed on a monitor receiving a signal from the personal video recorder of claim 1;

FIG. 3 is a diagram illustrating a daily planner view of recorded programs that can be displayed on a monitor receiving a signal from the personal video recorder of claim 1;

FIG. 4 is a diagram illustrating another daily planner view of recorded programs that can be displayed on a monitor receiving a signal from the personal video recorder of claim 1;

FIG. 5 is a diagram illustrating a multiply day planner view of recorded programs that can be displayed on a monitor receiving a signal from the personal video recorder of claim 1; and

FIG. 6 is a flow diagram illustrating a method of displaying recorded programs.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

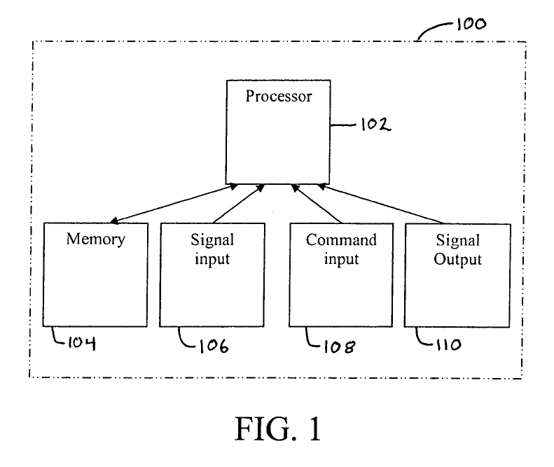

Referring to FIG. 1 a block diagram is shown illustrating a personal video recorder in accordance with the present invention. Shown is a personal video recorder 100, a processor 102, a memory 104, a signal input 106, a command input 108, and a signal output 110.

The personal video recorder (PVR) 100, also known as a digital video recorder comprises the processor 102, the memory 104, the signal input 106, the command input 108, and the signal output 110. The diagram shows a very broad overview of a personal video recorder such that it will be apparent that any digital recorder may be used in accordance with the present invention. The general configuration and operation of the personal video recorder 100 is known in the art and will not be described herein for the sake of brevity and clarity. Furthermore, common but well-understood elements that are useful or necessary are not depicted in order to facilitate a less obstructed view of the various embodiments of the present invention.

The signal input 106 can receive one or more of many different types of video signals and audio signals over any number of transmission channels, e.g., a video transmission channel. For example, the video or audio signal or combination thereof (also referred to as a content signal) can be an analog signal, a digital signal, or a high definition television signal. The audio signals and video signals and combinations thereof are all considered programs as referred to herein. Additionally, the transmission channel over which the video or audio signals are transmitted can be, for example, an over-the-air television broadcast, a cable line, or a satellite broadcast. Furthermore, along with the video or audio signal, the signal input can received programming data relating to the video or audio signal. For example, the programming data can be data for a programming guide. The transmission and display of a programming guide through a PVR 100 is known in the art and will not be described herein in great detail. The programming guide provides a user of the PVR with a convenient interface for determining the current television programs or audio signals being transmitted and also contains future programming information. Additionally, the programming guide provides the user with a convenient interface for selecting shows or audio files for recording. The following examples will be described in terms of video signals and television programs, however, the present invention is also applicable to audio signals and a program guide relating to the audio signals.

The command input 108 can receive one or more signals from any type of input device. The input device allows a user to input commands to the personal video recorder. For example, the command input can receive signals from a remote control, a keyboard, a mouse, and a microphone (voice recognition). The input device allows a user to select programs to record on the personal video recorder 100, can be used to later view the recorded programs or can be used to view a list of programs scheduled for future recording. In accordance with one embodiment, the command input 108 can receive signals from the input device that allows a user to navigate through a calendar that contains a list of programs scheduled for future recording. Additionally, the command input 108 can receive signals from the input device that allows a user to navigate through a calendar that contains a list of previously recorded programs.

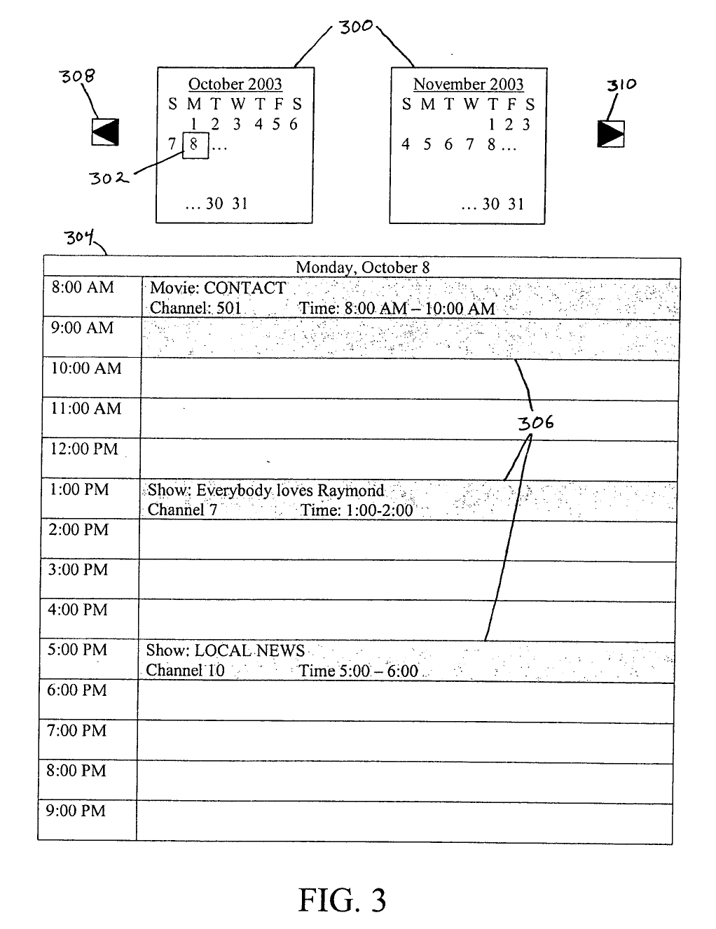

The signal output 110 can output video signals to almost any type of display monitor. For example, the signal output can output a digital television signal, an analog television signal, a high definition television signal. Generally, the output signal will correspond to a previously received video signal received though the signal input 106. In accordance with the present invention, the signal output 110 can output a signal that includes a calendar containing a listing of previously recorded programs. Previously recorded programs can be viewed through the calendar interface, and a user can select a recorded program to watch through the calendar interface. Examples of the calendar interface are shown in FIGS. 3, 4, and 5. In an alternative embodiment, programs scheduled for future recording can be viewed through the calendar interface.

The memory 104 can be many types of electronic storage medium such as are known in the art. The memory 104 stores recorded programs that are received at the signal input and that the user has selected for recording. In one embodiment, the memory is a hard drive that is capable of storing up to 80 hours of television programs. In other embodiments the hard drive can store between 10 and 200 hours of television programs. The present invention is not limited to the amount of storage space the personal video recorder 100 is capable of storing. The memory 104 can also be one or more storage devices within the PVR 100. In one embodiment, the memory 104 can have two memory devices, one for storing recorded programs and another for storing executable programs used by the processor. Thus, the memory 104 represents all of the memory in the PVR 100.

In one embodiment, the memory 104 also stores a listing of previously recorded programs and a listing of television programs scheduled for future recording. Additionally, the memory 104 can store the data associated with the program guide described above.

As mentioned above, the memory 104 also stores programs, i.e., sets of executable commands that are accessed by the processor. The processor 102 runs the programs and generates the output signals that will be sent through the signal output 106 to a display monitor.

In operation the processor 102 controls and generates the signals that will be output from the signal output 110 to the display monitor. In accordance with the present invention the processor 102 is configured to generate a signal for displaying a calendar, the calendar including either a listing of previously recorded programs or a listing of television programs scheduled for future recording. The processor 102 as shown can either be one processor or a combination of individual processors each with different tasks. The processor 102 thus represents any combination of one or more processors included in the personal video recorder 100. Thus, for example, one processor may control the generation of a video signal containing a calendar for a specified time period, the calendar including either a listing of previously recorded programs or a listing of programs scheduled for recording and a second processor can control the output of the video signal through the signal output 110. In accordance with one embodiment of the present invention, the processor 102 refers to a combination of any number of processors within the PVR 100.

In one embodiment of the present invention, the processor 102 retrieves a listing of recorded programs from memory for integration into a video signal with a calendar. In another embodiment, the processor 102 retrieves the list of recorded programs by determining what television programs have been previously recorded in memory. A video signal is then generated with a calendar for a specified time period, the calendar including the list of recorded programs that were originally recorded during the specified time period. Advantageously, the user is then able to see a visual representation of when a program was originally broadcast. This provides the user with a more user friendly way to access previously recorded shows as compared with a simple listing of all of the recorded shows stored in the memory 104.

Similarly, the processor 102 can generate a video signal including a calendar for a specified period of time, the calendar including a list of television programs scheduled to be recorded during the specified period of time. Advantageously, this provides the user with a user friendly interface for scheduling recording and modifying pending recording. Additionally, the user interface provides a user with the ability to resolve conflicts in recording time when more than an allowed number of programs are scheduled to be recorded at the same time. For example, most PVR's have the capability to record two programs at the same time. Therefore, if a user attempts to schedule more than two programs for recording at the same time, the PVR will provide the user with an error message. Advantageously, with the display of the calendar and the list of television programs scheduled to be recorded, a user can easily determine what conflict exists and then decide which programs to record.

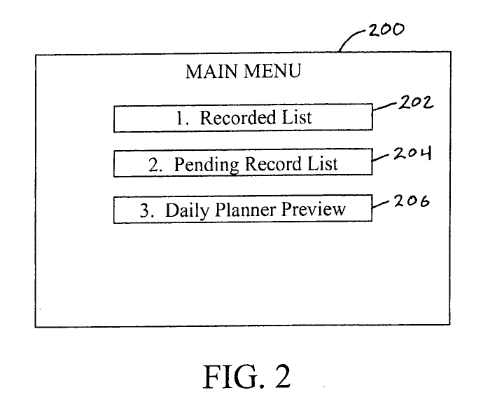

Referring to FIG. 2 a diagram is shown illustrating a main menu that can be displayed on a monitor receiving a video signal from the personal video recorder of FIG. 1. Shown is a main menu list 200, a recorded list 202, a pending record list 204 and a daily planner preview 206.

Prior designs for a personal video recorder only allowed for the display of a listing of previously recorded programs and a listing of programs that are pending recording through a list type format. In these designs the list would provide a user with the names of all of the programs and in most cases the date and time the programs were recorded. Other information about the program may have been also provided, such as a description of the program or a classification of the program. A user could then scroll through the list to try and find a desired previously recorded program. Additionally, a user could scroll through the list of programs that are pending recording.

Advantageously, in accordance with the present invention a menu is provided that allows a use to select between the recorded list 202, the pending record list 204 and the daily planner preview 206. When a user selects the daily planner preview 206 a video signal is generated by the processor 102 for displaying a calendar, the calendar includes a graphical representation of, for example, a listing of previously recorded programs during the time period of the calendar. The calendar displays the listing of the previously recorded programs to correspond to the time period the programs were originally recorded. In accordance with the present invention, the calendar may be viewed in different time increments. For example, the calendar may be displayed by the day, week or month. The recorded programs are then displayed on the calendar such that a user of the device can easily see what programs have been recorded or what programs are scheduled for recording. This provides the user with a friendly user interface for selecting the playback of a previously recorded programs.

Referring to FIG. 3 a diagram is shown illustrating a daily planner view of recorded programs that can be displayed on a monitor receiving a video signal from the personal video recorder of claim 1. Shown is a plurality of month calendars 300, a selected day 302, a daily calendar 304, a listing of recorded programs 306, a previous month arrow 308 and a next month arrow 310.

The diagram shows one example of a calendar that is displayed with the listing of recorded programs 306. Alternatively, the calendar can be displayed with a listing of programs scheduled to be recorded. In another alternative the calendar can be displayed with a combination of the listing of recorded programs 306 and the listing of programs scheduled to be recorded.

In the example shown, a user is able to select a day, shown as the selected day 302, from the plurality of month calendars 300. The daily calendar 304 of the selected day is then displayed with the listing of recorded programs 306. The listing of recorded programs 306 represents shows that were originally recorded on the selected day during the time they were originally recorded. This provides the user with a more convenient way to locate a show that was previously recorded as compared to a simple listing shown without the calendar.

In one embodiment of the present invention, a user is able to control the playback of the recorded programs through interaction with the listing of recorded programs 306 from the daily calendar 304. Additionally, a user can delete the previously recorded programs 306 from the daily calendar 304 by selecting one or more programs from the listing of recorded programs 306.

Additionally, when the calendar includes a listing of a program scheduled for recording the user can control the recording time or cancel the recording all together through interaction with the daily calendar 304.

The listing of recorded programs 306 or listing of programs scheduled for recording can include a plurality of program entries, each representing a specific program. Each of the plurality of program entries for the listing of recorded programs or the listing of programs scheduled to be recorded includes information about the television program. The information can include a channel number, a program description, a start time, and an end time. The listing of recorded programs highlights the time period on the calendar in which the programs were originally recorded, thus giving a graphical representation of the recorded shows. As described about displaying this information only in a list format does not intuitively illustrate the relationship of all the programs scheduled to be recorded with respect to themselves and to a time-of-day relationship. Advantageously, the present embodiments graphically illustrate in the daily planner format, the scheduling relationships. Additionally, when the calendar being displayed is a monthly calendar, the days that have recorded programs or have programs scheduled to be recorded can be highlighted.

A user can perform many operations on the daily planner format, such that the user can change the current daily planner date to another date from the displayed calendar, for example by selecting a forward or a backward arrow. A user is able to view different months of the year by selecting either the previous month arrow 308 or the next month arrow 310. Additionally, for example, the user can scroll down and select one of the programs to display further information about the program, the user can edit the currently scheduled recordings, the user can delete previous recordings, the user can add a recording, the user may select an internet link associated with a program, and the user can alternate between a program in the daily planner and the corresponding program in an electronic program guide. Upon editing any schedule information, any changes to the schedule will be updated in the memory, such that the change will be properly reflected in the entire PVR. Scheduling and changing scheduled recordings is known in the art and will not be described in detail herein.

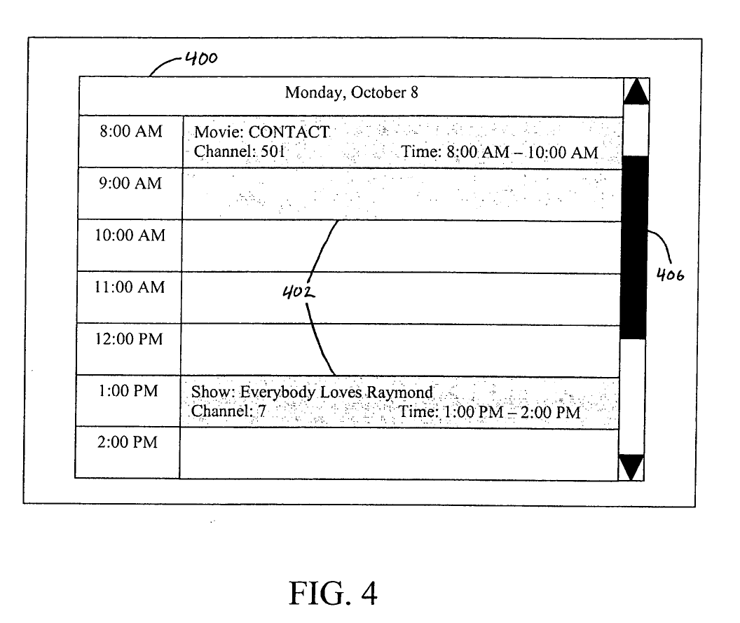

Referring to FIG. 4 a diagram is shown illustrating another daily planner view of recorded programs that can be displayed on a monitor receiving a signal from the personal video recorder of claim 1. Shown is a daily calendar 400, a listing of recorded programs 402, and a scroll bar 406.

A user is able to scroll through all of the times of the day by directing the scroll bar 406 to move upward or downward. As the scroll bar 406 moves upward, earlier times will be displayed on the daily calendar 400. As the scroll bar 406 moves downward, later times will be displayed on the daily calendar. The scroll bar 406 allows a user to view a listing of programs that may have been recorded at times not originally displayed by daily calendar 400. For example, the daily calendar 400 may initially display between 8:00 AM and 5:00 PM after a user selects the daily planner preview 206 from FIG. 2 or after a user selects a day from one of the plurality of monthly calendars 300. A user can then move the scroll bar 406 downward in order to view times between 5:00 PM and 10:00 PM. Additionally, if a selected day only has one listing for a recorded program, the time period displayed on the calendar may be automatically shifted to display that listing.

In one embodiment, a user would be able to move from one day to the next by pushing a button on a remote control, or by selecting a next day/previous day (not shown) button from the display.

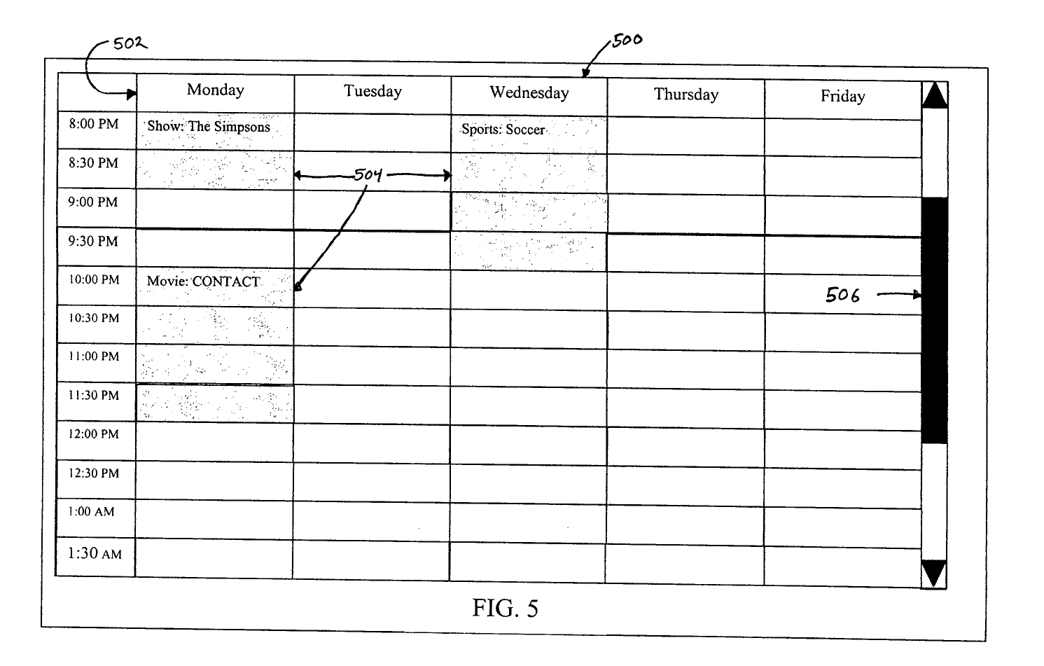

Referring to FIG. 5 a diagram is shown illustrating a multiple day planner view of recorded programs that can be displayed on a monitor receiving a signal from the personal video recorder of claim 1. Shown is a multiple day calendar 500, a plurality of days 502, a listing of recorded programs 504 and a scroll bar 506.

The multiple day calendar 500 provides a user with the ability to view a listing of previously recorded programs during a longer time period than the daily calendar shown in FIGS. 3 and 4. Advantageously, the multiple day calendar can also provide a user with the ability to see a schedule of recorded programs during a longer time period than the daily calendar. This allows a user to see in a graphical representation a listing of programs scheduled to be recorded. The graphical representation on the multiple day calendar 500 provides the user with a easy way to check which programs the user has scheduled for recording for the upcoming days.

FIGS. 3, 4 and 5 shown only three examples of calendars used to display a listing of recorded programs or a listing of programs scheduled to be recorded or combinations thereof, however, it is within the scope of the present invention that many additional features or changes may be made to the calendars. For example, the calendar can also use color differentiation to show previously viewed programs, previously recorded programs, programs scheduled to be recorded, and different categories of programs, such as sports, movies, and news. Additionally, any time period may be shown by the calendar, for example, the calendar may display only a partial day or the calendar may display an entire month.

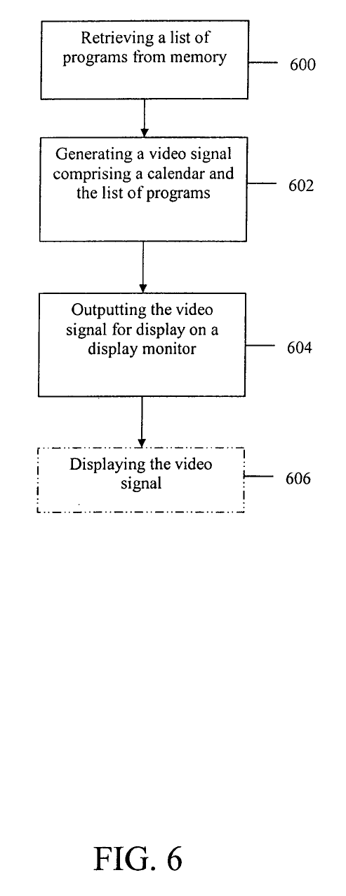

Referring to FIG. 6 a flow diagram is shown illustrating a method of displaying recorded programs. First a listing of programs from the memory of the PVR is retrieved by the processor 600. The programs are either previously recorded programs or programs scheduled to be recorded. Next a video signal is generated by the processor 602. The video signal includes a calendar, the calendar includes the listing of programs. The listing of programs will be shown in their originally recorded time period or in the time period scheduled for future recording.

Next the video signal is output for display by the processor 604 through the signal output 110. The video signal is output for display on a display monitor. Finally, in an optional step, the video signal is displayed on a display monitor 606.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

1. A method of displaying recorded programs comprising the steps of:
retrieving from memory a listing of programs for a given calendar period;
generating a video signal adapted for display on a display monitor, the video signal comprising a calendar representing the given calendar period and including the listing of programs; and
outputting the video signal for display on the display monitor.

2. The method of claim 1 further comprising the step of:
generating a video signal adapted for display on a display monitor, the video signal comprising a calendar representing the given calendar period and including a listing of a plurality of recorded programs for the calendar.

3. The method of claim 2 wherein at least two of the plurality of recorded programs have an overlapping record time.

4. The method of claim 1 further comprising displaying the video signal on a display monitor.

5. The method of claim 1 wherein the listing of recorded programs comprises a listing of a previously recorded program.

6. The method of claim 1 wherein the listing of recorded programs comprises a listing of a program scheduled to be recorded.

7. A digital recording device comprising:
a signal receiver for receiving a content signal;
a memory coupled to the signal receiver for storing the content signal; and
a processor coupled to the memory, the processor configured to generate a video signal for display on a display monitor, the video signal including a calendar for a given time period, the calendar including a listing of the stored content signal.

8. The digital recording device of claim 7 wherein the content signal comprises a plurality of television programs.

9. The digital recording device of claim 7 wherein the memory comprises a hard drive capable of storing at least 10 hours of video content.

10. The digital recording device of claim 7 further comprising a signal output for outputting the video signal for display on the display monitor.

11. The digital recording device of claim 7 further comprising the display monitor.

12. A digital recording device comprising:
a signal receiver for receiving a program guide, the program guide including a listing of a plurality of programs;
a memory coupled to the signal receiver for storing a list of scheduled programs for recording, the listing of scheduled programs for recording selected from the program guide; and
a processor coupled to the memory, the processor configured to generate a video signal for display on a display monitor, the video signal including a calendar for a given time period, the calendar including the listing of schedule programs for recording.

13. The digital recording device of claim 12 wherein the memory comprises a hard drive capable of storing at least 10 hours of video content.

14. The digital recording device of claim 12 further comprising a signal output for outputting the video signal for display on the display monitor.

15. The digital recording device of claim 12 further comprising the display monitor.
